(19) United States
(12) Patent Application Publication
(10) Pub. No.: US 2009/0125413 A1
(43) Pub. Date: May 14, 2009

(54) SYSTEMS, METHODS AND APPARATUS FOR CONTENT DISTRIBUTION

(75) Inventors: Vincent Le Chevalier, San Jose, CA (US); Gilbert Fuchsberg, New York, NY (US); Joseph M. Jacobson, Newton, MA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: FIRSTPAPER LLC, NEW YORK, NY (US)

(21) Appl. No.: 12/248,482

(22) Filed: Oct. 9, 2008

Related U.S. Application Data
(60) Provisional application No. 60/978,722, filed on Oct. 9, 2007.
(60) Provisional application No. 60/978,748, filed on Oct. 9, 2007.

(51) Int. Cl. G06Q 30/00; H04N 7/173; G06Q 50/00; G06F 17/30; G06Q 10/00; H04N 7/025

(52) U.S. Cl. 705/26; 725/32; 725/96; 725/92; 705/30; 707/3; 707/E17.014

(57) ABSTRACT

A system for and method of electronic content distribution is disclosed. Such content may be electronic book content, newspaper content, magazine content, and other types of content. The system includes: a processor having logic configured for filtering electronic content to remove incorrect information. The electronic content is automatically gathered from one or more content sources external to the system. The system also includes logic for assembling electronic content in a manner indicative of a predetermined template, and distributing the assembled electronic content for transmission at a scheduled time. The system also includes a communication network having an active channel configured to transmit the assembled electronic content. The system also includes a media device configured to receive and display the assembled electronic content when the media device is communicatively coupled to the active channel.

### CROSS REFERENCE TO RELATED APPLICATIONS

This application claims the benefit of priority to and incorporates by reference herein U.S. provisional application No. 60/978,722, titled “Methods and Apparatus for a Content Distribution Network,” and U.S. provisional application No. 60/978,748, titled “Content Distribution and Preloading,” each of which was filed on Oct. 9, 2007. This application incorporates by reference herein in its entirety U.S. provisional application No. 60/978,723, titled “Methods and Apparatus For Local and On-line Data Services,” and U.S. provisional application No. 60/978,717, titled “Foldable Media Device,” each of which was filed on Oct. 9, 2007. This application also incorporates by reference herein in its entirety U.S. non-provisional application titled “Methods, Apparatus, and Systems for Providing Local and Online Data Services,” and U.S. non-provisional application titled “Media Display Device and Method of Operating Thereof,” each of which was filed on Oct. 9, 2008.

### FIELD OF THE INVENTION

The present invention relates to content management, generally, and systems, methods and apparatus for media content management, in particular.

### BACKGROUND INFORMATION

Conventional content distribution networks face significant challenges due to the increasing complexity of digital media publishing. For example, challenges arise due to incompatibility of protocols, lack of information technology interoperability and static or incomplete feed databases. Challenges also arise due to the complexity inherent in performing electronic editorial rendering processes, providing network quality of service, and reporting and analyzing network performance and the effectiveness of advertising to targeted markets. Therefore, it is desirable to have systems, methods and apparatus for distributing content in an optimal format to a target audience in a cost-effective manner.

### BRIEF DESCRIPTION OF THE DRAWINGS

Purposes and scope of exemplary embodiments described below will be apparent from the following detailed description in conjunction with the appended drawings in which like reference characters are used to indicate like elements, and in which:

FIG. 1 is a block diagram of a content distribution network according to an embodiment of the invention;

FIG. 2 is a flow diagram illustrating the provisioning of services in the pre-production system of a content distribution network according to an embodiment of the invention;

FIG. 3 is a flow diagram illustrating the provisioning of services in the production system of a content distribution network according to an embodiment of the invention;

FIG. 4 is a flow diagram illustrating the provisioning of services in the distribution system of a content distribution network according to an embodiment of the invention;

FIG. 4A is a flow diagram illustrating multi-tiered level support services in the distribution system of FIG. 4; and

FIG. 5 is a block diagram of a subscription data processing system according to one embodiment of the invention.

### SUMMARY OF EMBODIMENTS OF THE INVENTION

In one embodiment, a system for electronic content distribution is disclosed. Such content may be electronic book content, newspaper content, magazine content, and other types of content. The system includes: a processor having logic configured for filtering electronic content to remove incorrect information. The electronic content is automatically gathered from one or more content sources external to the system. The system also includes logic for assembling electronic content in a manner indicative of a predetermined template, and distributing the assembled electronic content for transmission at a scheduled time. The system also includes a communication network having an active channel configured to transmit the assembled electronic content. The system also includes a media device configured to receive and display the assembled electronic content when the media device is communicatively coupled to the active channel.

In another embodiment, a system for electronic content distribution to a media device is disclosed. The system includes a content management system configured to automatically gather the electronic content from one or more content sources external to and communicatively coupled to the system. The system also includes a pre-processing system configured to: remove incorrect information from the gathered electronic content thereby generating an approved electronic content, and store the approved electronic content in a canonical database. The system also includes a processing system configured to: map the stored electronic content in a manner indicative of a predetermined template, assemble the mapped electronic content into a plurality of articles, perform quality control on the assembled electronic content, and generate a final version of the assembled electronic content. The system also includes a distribution system configured to: map the final version of the assembled electronic content to a scheduler configured to schedule distribution of the final version of the assembled electronic content. The distribution system is also configured to distribute at a scheduled time over a communication network to the media device, the final version of the assembled electronic content and information for formatting a layout of the final version of the assembled electronic content on the media device.

In another embodiment, a computer-implemented method of managing a subscription data processing system is disclosed. The method includes: providing information indicative of one or more types of subscriptions to electronic content offered for sale, receiving information indicative of a request to search the types of the subscriptions, searching a database according to the requested search, and providing information indicative of a result of searching the database. The method also includes receiving purchase information for purchasing at least one of the types of subscriptions offered for sale, and tracking sales of the types of subscriptions.

### DETAILED DESCRIPTION OF EMBODIMENTS OF THE INVENTION

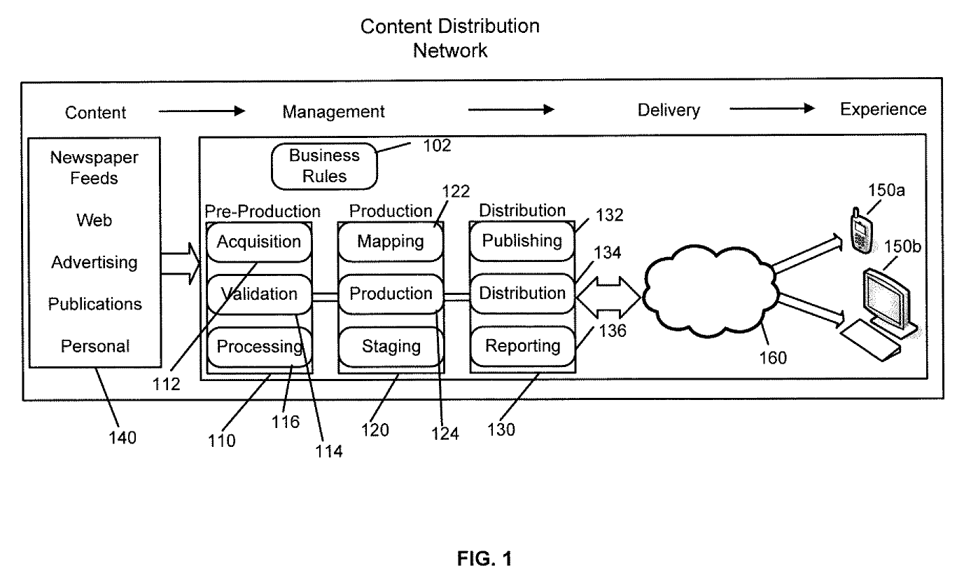

FIG. 1 is a block diagram of a content distribution network (“CDN”) according to an embodiment of the invention. In one embodiment, the CDN 100 may include a content management system 140, a business rules system 102, a pre-production system 110, a production system 120, a distribution system 130 and one or more reader devices 150a, 150b. The distribution system 130 may distribute content to the one or more reader devices 150a, 150b over communications network 160. Communications network 160 may be any wired or wireless network. In one embodiment, the communication network is an Internet Protocol (“IP”)-based network.

The pre-production system 110 may be communicatively coupled to the content management system 140 and the production system 120. The production system 120 may be communicatively coupled to the distribution system 130. In one embodiment, content may be aggregated at the content management system 140 and output from the content management system 140 to the pre-production system 110 for validation and processing. The processed content may be output from pre-production system 110 and received at the production system 120 for mapping and staging. The mapped and staged content may be output from the production system 120 and received at the distribution system 130 for publishing and distribution to the one or more reader devices 150a, 150b over the communications network 160.

The structure and functionality of the components of the content distribution network will now be discussed in further detail with various references to FIGS. 1, 2, 3, 4 and 4A.

Referring back to FIG. 1, the pre-production system 110 may receive sourced content from the content management system 140 and output processed content to the production system 120. The production system 120 may received the processed content and output staged content to the distribution system 130. The distribution system 130 may receive the staged content and output approved content to one or more of the reader devices 150a, 150b.

The content management system 140 may include logic for gathering, aggregating, managing and/or storing content of various types. In various embodiments, the types of content may include, but are not limited to, newspaper feeds or web, advertising, publications or personal information. The content management system 140 may be configured to gather and aggregate content from one or more sources, categories or content partners to the CDN 100 that provide content in association with the CDN 100. The content may be gathered and/or aggregated automatically in some embodiments, and the content management system 140 may gather and/or aggregate the content based on one or more criteria. The criteria may include, but is not limited to, whether the content is perishable, curated, on-line or personal.

The interfaces and/or processes to automatically gather content in the form of feed files may be as followed. A feed file may be an XML file that provides content or summaries of content, including metadata as well as optional links to full versions of the content. Feed files may be typically specified by a uniform resource locator (“URL”), but may be delivered to a local file system.

The content of feed files may be divided into two conceptual categories: embedded content and referenced content. The feed files may be archived for reuse and reference. Feeds with embedded content may contain all article metadata and other data. In some embodiments, no additional files or URLs may be needed to gather article content. Feeds with referenced content may contain article metadata in the feed file. The article metadata may reference separate individual article files that contain the article content. Article content data may be embedded directly in a feed file or contained in separate referenced article files. In either case, it may adhere to a regular structure in order to be parsed. Well-defined specifications (e.g., NewsML) may allow for reusable, high-level parsing strategies. However, loosely-defined structures (e.g., website templates that change frequently) may be much more difficult to process in a stable, generic fashion. Regardless of its original structure, all raw acquired content may be parsed and mapped into a data store in the content management system 140.

In some embodiments, the content management system 140 may utilize a strategy pattern to build various parsing strategies into a reusable framework. In various embodiments, the strategies may be provided in C#, Python and/or any other suitable framework. A selected strategy pattern may be used for multiple feeds that adhere to a common structure.

The strategy pattern may enable dynamically swapping of algorithms used in an application. The strategy pattern may be used to provide a mechanism for defining a family of algorithms, encapsulate each one as an object, and make them interchangeable. The strategy pattern may allow the algorithms to vary independently from clients that use them.

In the embodiments disclosed herein, the strategy pattern may be used for content acquisition. Various content providers may make their respective content available online in a selected standardized form (e.g. XML feed, HTML page). The content management system 140 may then parse the content, so as to extract a common subset of information. Since separate sources of content may share a common content structure, it is desirable to have a CDN 100 that is flexible enough to apply reusable, shared content parsing algorithms. By way of example, but not limitation, a specific example may involve multiple content providers who each provide XML content that adheres to version 1.2 of the NewsML standard (www.newsml.org) with embedded XML content that adheres to version 3.4 of the NITF standard (www.nitf.org). In each case, the content management system 140 may make use of the same programmatic parsing algorithm, hence following the Gang of Four strategy pattern.

In various embodiments, multiple feeds may be content from multiple publications. Furthermore, the systems may be able to successfully handle multiple data content structures within a single publication or feed.

The following attributes may be collected for one or more of the articles: the date the article was initially published, an abridged article synopsis, the full article text, headlines, sub-headlines, kickers associated with an article, and/or images associated with the article.

In some embodiments, a content specification may be specified to publishers that provide content. The content specification may provide detailed, technical requirements to publishers who wish to provide content so that the content may be seamlessly received by the CDN. In various embodiments, the content specification may require that information be provided in the following order: publication, feed, article, and advertising. In other embodiments, other arrangements of the information are possible.

The business rules system 102 may include a workflow engine configured to manage and execute modeled business processes. Each step in the operation of the workflow engine may be indicative of a business rule. The one or more business rules, and an order thereof, that the workflow engine may perform may be indicative of a specific template associated with a feed or publication in which content is received at the content management system 140. In one embodiment, these business rules and/or order thereof are completed for each article or publication processed through the workflow engine. In various embodiments, the business rules system 102 may include a workflow engine that operates according to one or more of the following rules: content enters the system through the feed; content is stored in a content repository, such as the content management system 140; various validation rules may be executed on the content; various pre-production rules are executed, the results of which may be stored back in the content management system 140; various production rules are executed, the results of which may be stored back in the content management system 140; the distribution system 130 may receive the results of the production system and distribute to reader devices 150a, 150b. In one embodiment, the CDN 100 operates according to an amalgamation of the aforementioned business rules as applied through the workflow engine of the business rules system 102.

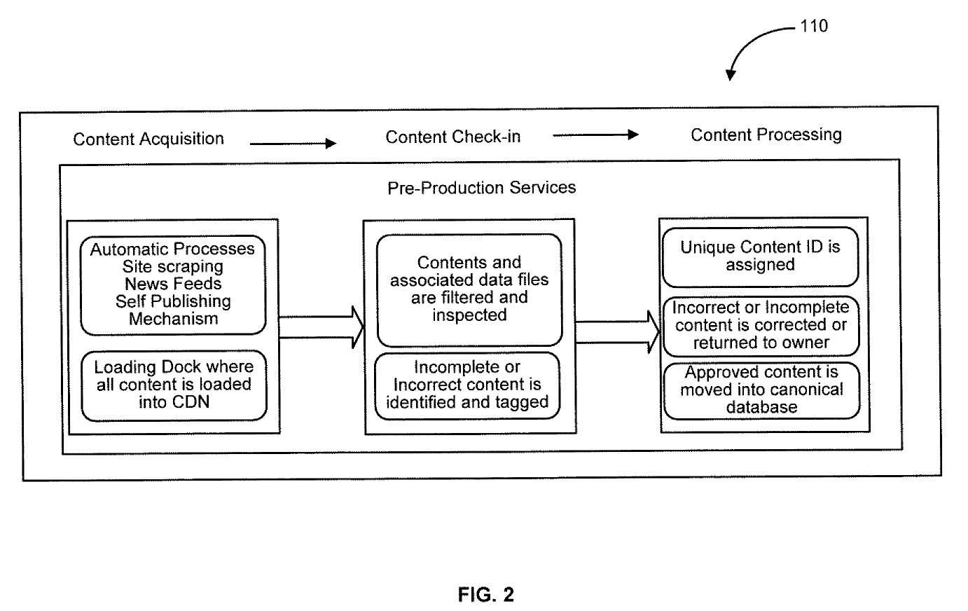

FIG. 2 is a flow diagram illustrating the provisioning of services in the pre-production system of a content distribution network according to an embodiment of the invention. Referring to FIGS. 1 and 2, the pre-production system 110 may be configured to validate content and store approved content in a canonical database. The pre-production system 110 may be communicatively coupled to and be configured to receive content from the content management system 140. In one embodiment, the pre-production system 110 may include acquisition logic 112 configured to receive the content, validation logic 114 configured to determine whether the received content is valid and processing logic 116 configured to prepare and assemble the received content. The received content may be assembled according to one or more business rules prior to distribution to other networks via the distribution system 130. In various embodiments, a set of the business rules used in the CDN 100 may increase, decrease and/or change over time in various embodiments.

By way of example, but not limitation, the business rule may be one: the content must meet a minimum length requirement for the particular publication and/or feed; the content must not contain character sequences that do not exist in the expected character set, e.g. it would fail validation if the feed is expected to be ASCII and non-ASCII characters are detected; the content must contain all required fields for the feed (e.g., author, title); and/or an analysis of the content of the article and/or data for the purpose of advertisement targeting must be performed.

The acquisition logic 112 may perform automated content acquisition. In one embodiment of automated content acquisition, a source of viable content may be identified and the content may be automatically retrieved by virtual agents configured to search approved websites and feeds for the latest set of data. The acquisition logic may include a website scraping or self-publishing mechanism. In one embodiment, a set of selected feed may each be tagged with contextual identifiers. In some embodiments, the selected feed may be tagged with a url (e.g., http://del.icio.us). Virtual agents may select among sources of content and aggregate the multiple sources of content together to create a personalized digital edition. Self-publishing may include the configuration and aggregation of the multiple sources of content.

The acquisition logic 112 may download the sourced content to a temporary storage location on a selected server on the CDN 100 before the sourced content is validated and processed with the validation logic 114 and the processing logic 116, respectively.

The validation logic 114 may be configured to filter and inspect the sourced content and any data files associated with the content. Filtering may be performing using custom filters configured to identify complete and/or correct content.

In various embodiments, filtering may be performed by one or more of the following methods: document object model (“DOM”) manipulation may be used to provide facades for data manipulation of XML or HTML information, LINQ to XML transforms/annotations techniques may be used for transforming content from one form to another form, such as that provided by XSLT, the Html parser may be used for providing a parser that may build a read/write DOM and support plain XPATH or XSLT, and/or an expression engine may be used for providing a bank of expressions used to replace specific portions of content. In one embodiment, the HTML parser may be an HTML Agility pack.

The HTML parser may allow parsing of content and/or data feeds that are not specifically cleaned or setup by the publisher for the CDN. Accordingly, in one embodiment, the HTML parser may allow parsing of a public website containing news articles or other publishable data. The parser may be very tolerant with real world malformed HTML. The object model may be very similar to System.Xml, but for HTML documents (or streams). The expression engine may be applied universally across all text, as distinguished from the DOM-based approaches.

The validation logic 114 may be configured to identify incorrect or incomplete content. The identified content may be tagged for performing further action with regard to the content due to a lack of standards and interoperability between existing feeds and other sources of contents.

In some embodiments, incorrect content may be flagged, isolated and returned to the owner of the content. Specifically, articles with incorrect content may be automatically removed from the production processes so that digital editions may be completed and provided to the staging process for quality assurance. As used herein, the term “digital edition” means an electronic version of information, an electronic version of a newspaper, an electronic version of a book and/or an electronic version of a magazine.

There are a number of possible behaviors of the CDN 100 after a validation failure is detected. Error detection during the processing in the content management system 140, pre-production system 110 and/or production system 120 may cause any number of different actions to be taken. Accordingly, the CDN 100 actions of correcting and/or returning incorrect content to publishers are merely exemplary and other actions are envisaged herein, which may vary depending on a variety of factors. In various embodiments, the factors may include, but are not limited to, the criticality of an incorrect or incomplete article to the digital edition, and the desires of the publisher. By way of example, but not limitation, actions that may be taken include: notification to the publisher, freeze processing the entire digital edition, removal of the specific article from the digital edition, and/or attempting to correct the problem with a known solution. In some embodiments, no action may be taken.

Once a digital edition with incorrect content has been flagged, an analysis may be performed to determine why the initial content was flagged and removed. Potential fixes may range from correcting bad characters or strings by having an internal quality assurance team update the content as it is stored into an internal database to having the content owner re-submit the entire article and re-building the digital edition. The quality assurance process may be performed before publishing the content.

The CDN 100 may also provide the ability for publishers to see the automated modifications that have been made to the articles and/or if articles have been removed, as well as the manual steps performed to modify a digital edition prior to final publication. Before distribution, the publisher may be able to approve/disapprove the modifications within a specific time frame (e.g., 30 minutes, one hour, 24 hours) after a publisher has been provided with the ability to see the modifications.

The processing logic 116 may be configured to assign a content identification to filtered content, correct or return incorrect or incomplete content to its owner for action, and/or approve the filtered content and store the approved content in the canonical database.

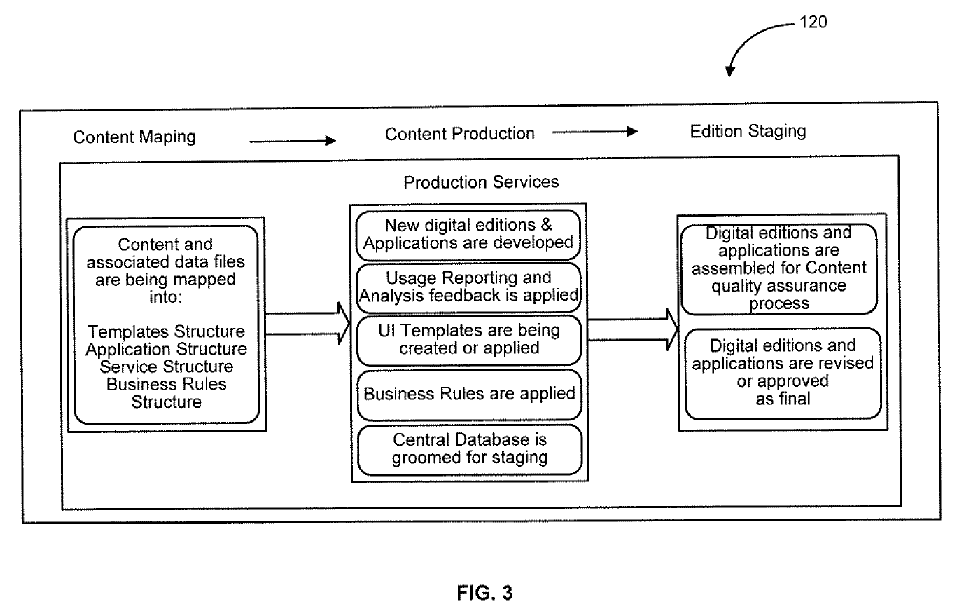

FIG. 3 is a flow diagram illustrating the provisioning of services in the production system of a content distribution network according to an embodiment of the invention. Referring to FIGS. 1 and 3, the production system 120 may include mapping logic 122 configured to map content stored in the canonical database and associated data files to one or more of: a template structure indicative of the type of template of the content, an application structure, a service structure indicative of a type of service offered and/or a business rules and content policies for the content.

In various embodiments, application structures may include active templates, which include a template that may reside on the reader device 150a, 150b, and wherein a process on the reader device 150a, 150b provides topical and/or real-time content into the template residing on the reader device 150a, 150b. The template resident on the reader device 150a, 150b may be used to display the content in lieu of a pre-formatted, paginated template.

In some embodiments, content polices may refer to filtering or formatting rules applied to an active stream of content, which could be resident on the reader device 150a or any other component of the CDN 100, including, but not limited to, a server in the CDN 100. The content polices may be provided for the purpose of displaying personalized content on the reader device 150a. By way of example, but not limitation, a sortable top level presentation layer may display some or all of the documents in a personal library of a user of the reader device 150a. The library may be local and reside on the reader device 150a and/or on-line.

The production system 120 may include production logic 124 configured to automatically create a digital edition. The production logic 124 may include content rendering and newspaper layout capabilities for automatically assembling the digital edition.

In one embodiment, the production logic 124 may include logic configured to perform one or more of the following: developing new digital editions and/or applications, applying usage reporting and analysis feedback, creating and/or applying user interface templates, applying one or more business rules, and/or preparing a central database for staging.

In various embodiments, business rules may include, but are not limited to, sending a notification about initialization or completion of a particular phase of processing in the CDN 100, combining content from several feeds into a digital edition, recording into a database one or more metrics indicative of the processing in the production system 120, and/or digital rights management on the constructed digital edition or its constituent pieces.

In one embodiment, preparing a central database for staging may include providing a completed publication for external review by the publisher of the content.

The production system 120 may include staging logic 126 configured to assemble and/or test the assembled digital edition to determine whether the digital edition or an application is ready for distribution. In some embodiments, the edition or application is tested using a quality assurance process. The quality assurance process may test the distribution system 130 and/or the reader device 150a, and may reside on either the distribution system 130 or the reader device 150a. The distribution system 130 may be tested on a number of factors, including, but not limited to, download duration, file size, re-transmission rate or any other aspects of the distribution of the digital edition from the distribution system 130 to the reader device 150a. The reader device 150a may include an automated quality assurance process residing on the reader device 150a that may test a number of factors, including, but not limited to, opening the digital edition, checking page count and/or checking an amount of whitespace on each page of the digital edition. These metrics may be reported back to a server of the CDN 100 disposed to receive metrics.

In one embodiment, the quality assurance process may be an automated process. One or more of the following automated functions may be performed: discarding of invalid data not discarded during the validation process, real-time monitoring of the health of server services and processes, determining whether a threshold has been met regarding a number of articles, and file size for the articles, and/or flagging and/or removing incorrect data. One or more of the following manual processes may be performed: internal review by quality assurance team, providing a publisher portal for approval of the content within a limited amount of time (e.g. 30 minutes, one hour, 24 hours) and time-out after the time has elapsed, investigation of incorrect data for possible re-submission, and/or user interface-operated control. User-interface operated control may be used to perform one or more of the following functions: ordering articles, including or excluding articles, and/or flagging articles for special sections. Articles may be provided in the default sections of the digital edition by automatic determination by the system. The special sections of the digital edition may include, but are not limited to, the front page, section front page and/or the summary view column.

If the digital edition or application is ready for distribution, the staging logic 126 may flag the respective edition or application. The digital editions or applications may be revised or approved as a final version ready for distribution.

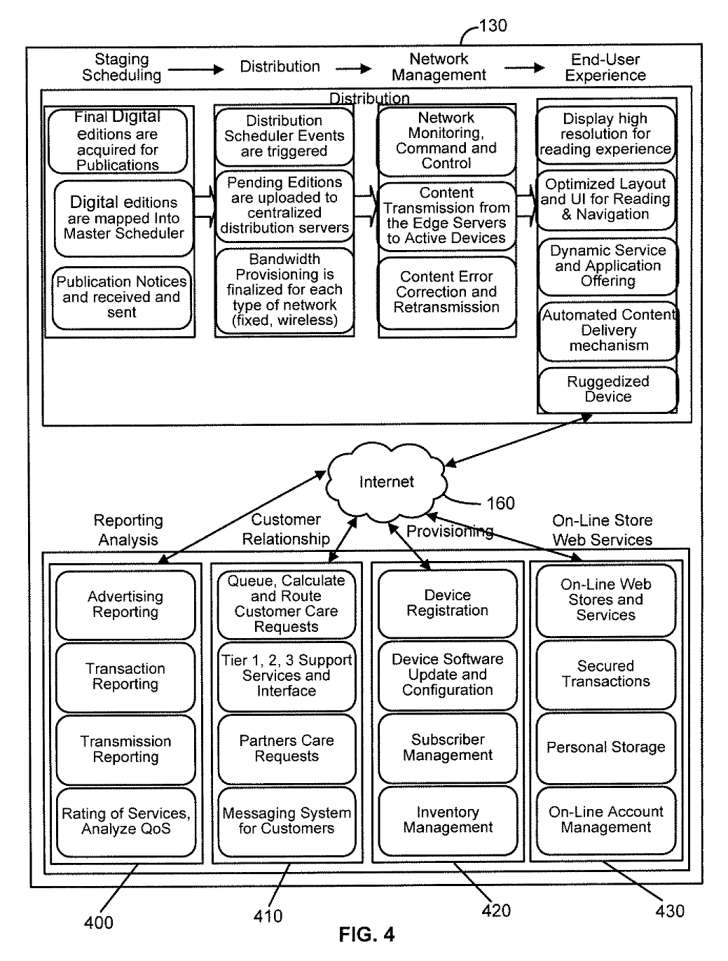

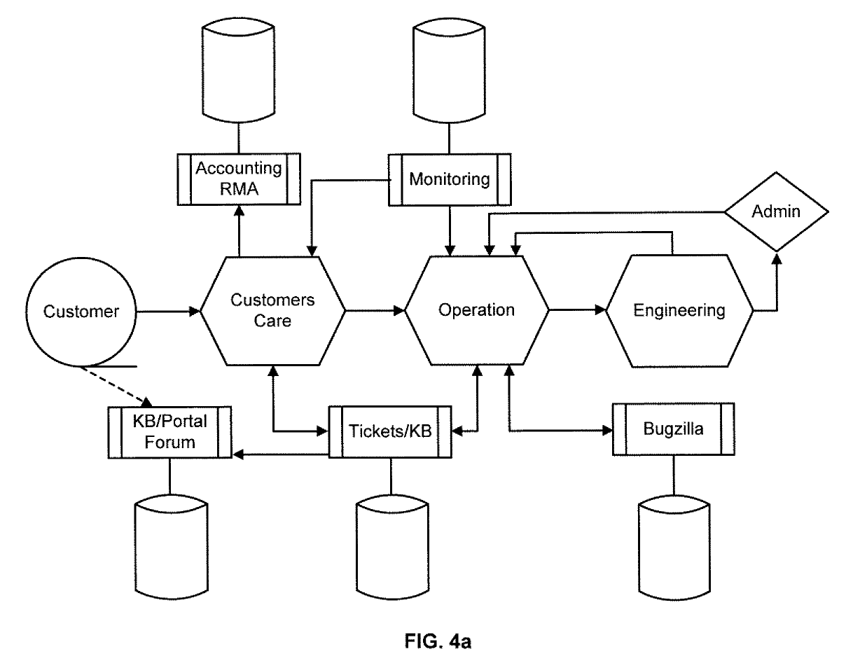

FIG. 4 is a flow diagram illustrating the provisioning of services in the distribution system of a content distribution network according to an embodiment of the invention. From the distribution system 130, content may be transmitted to one or more available communication networks 160 for transmission to one or more reader devices 150a, 150b. The distribution system 130 may include all or a substantial majority of the services offered by the CDN 100. In embodiments wherein the distribution system 130 is fully operational, it may provide high (e.g., 85%-95%) availability for the CDN 100 including characteristics such as little or no (e.g., 0%-10%) perceived network downtime and/or good network fault tolerance (e.g., a probability of less than 10% that the network will experience disconnection).

Referring to FIGS. 1 and 4, the distribution system 130 may include publishing logic configured to publish the edition, and distribution logic configured to distribute formatted content and services over the communication network 160 to one or more of the reader devices 150a, 150b. The distribution logic may be configured to perform methods for optimizing network bandwidth consumption for unicast or multicast distribution and/or for providing guaranteed on-time content delivery services. For example, the distribution logic may perform one of the aforementioned methods to ensure timely distribution of content to subscribers possessing reader devices 150a, 150b. By way of example, but not limitation, timely distribution of content to subscribers may include distribution every morning, every evening, at 7 a.m., 7 p.m. and/or any other selected time interval or time.

There may be a plurality of managed factors and constraints in the CDN regarding on-time content delivery services to assure that distribution to a reader device 150a, 150b is performed on-time. In some embodiments, performing distribution on-time may include performing distribution up to 10 minutes after the targeted distribution time. The factors may include, but are not limited to, off-peak network window constraints (e.g., 1 a.m. to 6 a.m.), feed availability time, feed ingestion, review content preparation, content review (and approval or re-build), and/or content download from a reader device that wakes up on its own to retrieve the data. A complex engine may consider one or more of these variables in the workflow engine to improve the likelihood of on-time delivery. This may be similar to print newspaper distribution processes, and timing constraints, but may be applied to an electronic edition.

In one embodiment, a master scheduler may link every file to be published to a selected reader device. The rules for the master schedule may include one or more of the following: subscribed content and electronic newspapers may be delivered to the reader device at the same time, or earlier, than the corresponding print version, the content distribution strategy may be optimized for off-peak wireless broadband usage times (e.g. 9 p.m. to 6 a.m.), the geographical time zone (e.g., Pacific Standard Time, Eastern Standard Time, Greenwich Mean Time) of the reader device may be considered, the reader devices power up, establish a network connection and download subscribed content automatically without any end-user inputs, reader device network connection time may be optimized so as to limit power consumption and battery life (e.g., limiting network connection time to 15 minutes or one hour), subscribed content may be compressed on the server and optimized for content delivery and/or file size, regular updates, such as hourly breaking news updates may be optimized for minimizing peak hours network connection time, a connection manager associated with the reader device may continually (e.g., hourly or 2-3 times daily) search for lowest cost network and/or content available, the connection manager may obtain a network time and scheduler from content distribution scheduler, and/or content and services may be directed to different networks based on their respective business rules.

The distribution system 130 may include staging and scheduling logic configured to acquire final digital editions for publication and mapped the final digital editions into a scheduler. In one embodiment, the staging and scheduling logic may schedule the final digital editions to be provided to reader devices at approximately the same time as hard copy, paper editions (e.g., within 5 minutes before or after the delivery of the hard copy, paper editions). In order to ensure timely distribution of the final digital editions, the propagation time for a digital edition to be received at a reader device may be estimated. The estimation may be used to provide distribution to meet a selected level of quality of service. Files in the staging area may be first compressed prior to being published, and then matched to services according to specific rules which may prioritize them based on when these files have to be published.

In some embodiments, the estimation may incorporate one or more of the following factors: the size of the edition, the population of local subscribers in a target market, the performance of a local metropolitan network, and/or the applicable time zone of the target market. Propagation time may be a variable based on file size, type of network, quality of reception and other parameters. Based on the content and services to be delivered, the distribution system 130 may estimate the best time for publishing that content across population of devices and geographies. Taking in consideration the uncertain nature of wireless delivery networks, the propagation time may be better defined as a time window (e.g., 5 minutes, 15 minutes, 30 minutes, one hour) for successfully delivering the subscribed content to devices in the field. The propagation time may be estimated at regular intervals during the day (e.g., every morning, every evening, 2-3 times a day) to accommodate and/or optimize regular and flash updates of the basic news information services. For example, reader devices sharing a similar network node, may be given slightly different connection times so that local network traffic can be optimized and reduce the chances of overloading the network. On a statistical basis, a number of attempted re-transmissions may be factored in for bad network connection. The more devices per node, the longer the estimated time window for the content to be effectively delivered may be.

In some embodiments, the propagation time estimation may be based on an algorithm combining one or more factors towards obtaining efficient and effective on-time delivery. The factors may include, but are not limited to, the time required for delivery (and/or the time zone that the reader device is in and how many people are in the same area), and/or the network pipes available when the content is downloaded to the reader device

The distribution system 130 may include distribution scheduling logic that may be configured to initiate the distribution of the content based on the outcome of the staging and scheduling logic. The distribution and scheduling logic may be configured to perform one or more of the following functions: triggering events that require scheduling, uploading the final editions to centralized distribution servers, and/or provisioning of bandwidth for one or more types of networks over which the edition will be distributed. Provisioning bandwidth may be performed by associating a reader device with a particular network at a selected time based on a number of factors that may include, but is not limited to, which network may be most cost-effective.

In one embodiment, the distribution scheduling logic may consider the type of the communication network 160 that may be used to delivery the content. For example, the type of the internet protocol (“IP”) network may be considered. The type of network may be a dedicated wireless network or a network defined by an internet service provider (“ISP”) used by the reader device 150a, 150b. The dedicated wireless network may be the network provided by Verizon or any other service provider. The ISP may provide wired or Wi-Fi connectivity or public Wi-Fi connectivity.

The distribution and scheduling logic may also associate a reader device with a particular network at a selected time based on a number of factors that may include, but is not limited to, which network may be most cost-effective. For example, if the communication networks 160 to which the reader device is communicatively coupled is a local ISP service network and a dedicated wireless network, the distribution and scheduling logic may route the content to the most cost-effective network available. Accordingly, the use of bandwidth may be managed and/or optimized. Effective bandwidth management and optimization may be used to reduce the load and stress on the communication network 160 and the distribution system of the CDN 100.

The distribution system 130 may include network management logic configured to receive the information generated by the distribution and scheduling logic along with the content. The network management logic may also be configured to monitor and control one or more communication networks 160, transmit content to one or more edge servers and from the one or more edge servers to reader devices, and/or perform content error correction and/or retransmission. In one embodiment, the CDN may include network operators that may receive from the network provider pseudo-real-time feedback on various aspects of the communication network 160. The network operators may have the capability to perform network management based on the feedback.

The distribution system 130 may include end user experience logic configured to provide an optimal layout and user interface navigation, distribute selected services and applications to reader devices for enhanced service, and/or provide automatic downloading of the content to the reader device. The end user experience logic may transmit and receive information over the communication network 160 between the reader device and the distribution system 130.

In one embodiment, with power on, the reader device may locate a communication channel without receipt of any user-initiated inputs and/or with a high degree of autonomy. The reader device may then periodically (e.g., every 15 minutes, every hour, 2-3 times a day, every 24 hours) locate information, including, but not limited to, subscriptions intended for the reader device. Further, important updates may automatically be downloaded into the reader device and appear in the appropriate rank order within the hierarchy of documents and/or news information. Accordingly, in this embodiment, the user of the reader device may not be required to initiate downloading of updates. The reader device may refresh its system so that the latest updated information may be downloaded automatically to the reader device and be available to the reader device if it is not powered off. Web-based applications with transaction-level security may perform the functions of automatically downloading information, including, but not limited to, important updates. The web-based applications may be offered as a standalone application or syndicated via existing branded websites of participating publishers.

The end user experience logic may interoperate with the reader device to provide one or more of the above functions. For example, the reader devices 150a, 150b may include one or more display panels configured to provide high resolution, paper quality textual and/or graphical images. In one embodiment, the pixels per inch and pixel resolution may be high resolution. For example, the pixel resolution may be 1600×1200.

The content layout and user interface navigation capabilities may be optimized to provide for easy searching, presentation and navigation of the content. The content for an electronic newspaper edition, for example, may include hundreds of articles, arranged in dozens of categories or sections, with complex editorial concepts, and the content layout and user interface navigation capabilities may significantly enhance the use of the reader device.

The distribution system 130 may include reporting analysis logic 400 configured to receive, aggregate and analysis information reported to the distribution system 130. In one embodiment, the reported information may be feedback from end users regarding advertising data provided to the end user through the CDN 100. The user may provide direct, qualitative feedback regarding the advertising data. The distribution system 130 may analyze the reported information in real-time in some embodiments. The information may be provided to advertisers. In some embodiments, the distribution system 130 includes an advertising server configured to facilitate the process of receiving, aggregating and analyzing the advertising feedback.

In other embodiments, the reported information may include, but is not limited to, information indicative of financial transactions from end user's purchasing content and/or services, local network transmission quality and reliability, the health and/or status of the end user's reader device, and/or a rating of services provided by the CDN 100, including quality of service information. The reporting analysis logic 400 may transmit and receive information over the communications network 160 between customers (or reader devices used by the customers) and/or partners, and the distribution system 130 to provide the reporting functionality.

In some embodiments, the distribution system 130 may be configured with customer relationship management logic 410 to provide management of the relationship between the CDN and customers, which may include, but is not limited to, end users. The logic 410 may provide one or more of the following functions: multi-tiered level support services wherein customer calls may be queued, prioritized and/or routed according to a selected level of support service, partner care request services, and/or messaging services for customers.

Multi-tiered level support services that queue, prioritize and/or route customer calls may be structured as illustrated in FIG. 4A. The customer service infrastructure shown in FIG. 4A may be employed to address issues arising between the user, the reader device 150a and the functionality of any other systems of the CDN 100. In one embodiment, the customer service infrastructure may be a customer service infrastructure system from SAP, Microsoft or the like. In FIG. 4A, the infrastructure may include one or more of the following functions wherein the “Customer” block may represent handling issues related to the user of the reader device 150a, the “KB/Portal Forum” block may represent handling issues related to the an on-line, web-based knowledge base and discussion forum, the “Customers Care” block may represent handling issues related to the a customer history database that may maintain hardware ownership, previous support incidents, and other information, the “Operations” block may represent handling issues related to the maintenance of any servers and network infrastructure in the CDN 100 and/or promoting issues to Engineering, the “Engineering” block may represent handling issues related to the software modification in response to specific trouble tickets or enhancement requests, the “Tickets/KB” block may represent a trouble ticket mechanism for tracking customer problems through an organization overseeing the CDN 100, the “Admin” block may represent end user account management, the “Accounting RMA” block may represent handling issues related to the hardware management software and/or bridging the infrastructure with a financial system, the “Bugzilla” block may represent handling software bugs and/or the “Monitoring” block may represent handling issues related to the device and server health status.

The customer relationship management logic 410 may transmit and receive information over the communications network 160 between customers (or reader devices used by the customers) and/or partners, and the distribution system 130 to provide the customer relationship management.

In some embodiments, the distribution system 130 may be configured with provisioning logic 420 to provide functionality related to reader device management. In various embodiments, the provisioning logic 420 may provide one or more of the following functions: reader device registration, reader device firmware or other software update and/or configuration, subscriber management, and/or inventory management. The provisioning logic 420 may transmit and receive information over the communications network 160 between an original design manufacturing partner along with existing distribution channels and/or distribution channel service providers, such as cellular wireless service providers, and the distribution system 130.

In some embodiments, the distribution system 130 may be configured with online store and web services logic 430 and/or application servers configured to allow users to securely select and subscribe to a variety of services and/or categories of content. The logic 430 may provide a powerful central repository and store where subscribers can select, buy and customize content that may be optimized for their reader devices, from among multiple newspapers, magazines and other sources. In some embodiments, this capability may be syndicated to participating newspapers, for them to brand and offer via their own websites.

In various embodiments, the online store and web services logic 430 may provide one or more of the following functions: selling of goods and services, provisioning of security during financial transactions, provisioning of personal online storage space for end users, and/or online end user account management.

In one embodiment, a news and information service may be supported online by a dedicated electronic newsstand that proposes available electronic newspapers and sections thereof as individual subscriptions. In another embodiment, a game, book or manga service may be supported and provided for purpose through one or more electronic book stores. In yet another embodiment, an end user may be able to create an online personal library, a storage location for saving articles, personal files or any other content in a secure and personalized area that is the end user's online personal storage location.

In yet another embodiment, a stand alone print-to-device server application may convert any type of document or web page into formatted content optimized for e-reader platforms provided on the reader device.

The online store and web services logic 430 may transmit and receive information over the communications network 160 between customers (or reader devices used by the customers) and/or partners, and the distribution system 130 to provide the services.

Referring to FIG. 1, the reader devices 150a, SOb will be described in greater detail. The following description will describe embodiment of the invention including reader device 150a only; however, the same description applies to embodiments of the invention including reader device 150b in addition to or in lieu of reader device 150a.

The reader devices 150a, 150b may include one or more display panels coupled to a substrate that may be of a material and/or form that is resistant to breakage. In some embodiments, the reader devices 150a, 150b may be dust proof and/or water proof.

Services and applications may be distributed to the reader devices 150a, 150b when the CDN is in operations mode. In one embodiment, a blueprint for all paginated content may be created on a server in the CDN 100 but the content assembly may be performed on the reader device 150 using application software and a renderer provided on the reader device. The blueprint may determine the arrangement of the content in the digital edition, the application may interpret the blueprint and the renderer may reconstruct the paginated content.

In one embodiment, the application may be built with enough flexibility and scalability to be able to support a range of possible devices, iterations, variants and generations from multiple vendors. Screen sizes, processing capacity and communications speeds may vary, but the basic standards and formats for saving and storing content may be designed to be stable over time and perform across multiple device platforms and/or accommodate existing standards for electronic books, documents (e.g., .pdf versions of documents) and rich site summary (“RSS”) feeds, as well as basic Web standards (e.g., HTML and XML standards).

While a primary edition and service may be distributed initially, and other services may be distributed independently from other services, enhanced service may be distributed to allow the user to choose to receive premium service at the reader device 150a.

Content may be automatically downloaded to the reader device 150a without user interaction, and according to a schedule. Accordingly, the newspaper edition, for example, may be automatically provided to the reader device during the early morning hours when users typically read the newspaper.

The reader devices 150a, 150b may be any type of device configured to receive and display content received over one or more channels from a network, such as the CDN 100. In some embodiments, the reader device 150a may be any type of device configured to be preloaded with content and to allow access to a user of the reader device 150a when no channels are active. In one embodiment, the reader device 150a may include, but is not limited to, an E-Ink® device, and/or a personal computer.

In one embodiment, a connection manager (not shown) in the CDN 100 may include middleware for bridging the applications and services operating on the reader device to the various networks available to the reader devices. Each network may be given a set of rules and/or may be prioritized according to the associated cost, quality, speed and/or actual content to download, and type of services. In one embodiment, a universal serial bus (“USB”) network operation may be performed if a link is detected, a Wi-Fi network that is configured and available at the time of the connection may begin to operate, and/or a wireless broadband network may begin to operate.

Based on a required level of service and other business rules, the connection manager may forgo initiating a network connection. As an example, wireless broadband network traffic for specific services may be directed to off-peak hours only (e.g., 1 a.m. to 6 a.m.), as opposed to peak hours (e.g., 4 p.m. to 9 p.m.) even if connection is available at all times. Similarly, premium and basic services may be differentiated based on which networks are authorized to them.

A scheduler for the reader device may power up when it is time to retrieve the subscribed content. For example, the device may power up at 5 a.m., connect to CDN servers to download content, then power back down or go into a sleep mode after downloading the content.

The reader device 150a may be communicatively coupled to the CDN 100 through one or more physical or virtual channels that may provide an interface to the reader device 150a. In some embodiments, the physical or virtual channels may be any type and/or number as long as a consistent interface to the reader device 150a is provided.

In one embodiment of the system, the reader devices 150a, 150b may be as described presently. The reader device 150a may be in contact with the CDN 100 using one or more channels that provide a fairly consistent interface to the device from the CDN 100. Different types of channels may be used for different types of communications. In various embodiments, a channel may be a broadcast or multicast channel intended to communicate information at low-cost to a selected group of reader devices. For example, news, sports or weather may be broadcast or multicast. In other embodiments, a channel may be used to narrowcast or pointcast content intended for a smaller group of reader devices 150a, 150b at a higher cost. For example, content including, but not limited to, advertisements, geographically localized information, may be transmitted by narrowcast or pointcast. The narrowcast or pointcast channels may supplement the broadcast or multicast channels.

The content may be transmitted over any type of channel in real-time or at scheduled intervals to allow for economization of transmission costs. For example, a CDN 100 may deliver scheduled traffic updates two or three times a day at scheduled times. As another example, a reader device 150a may aggregate and cache a user's response to a particular advertisement and provide that response information to the CDN 100 during off-peak hours (e.g., 1 a.m. to 6 a.m.). In some embodiments, a channel may be established at any time during which it is economical to establish the channel.

In some embodiments, the reader device 150a may be configured to receive preloaded content. The preloaded content may be loaded into the reader device at any number of time periods before the content is viewed by a user using the reader device. In various embodiments, the content may be preloaded at the time of manufacture or the point of sale of the reader device 150a, and/or at the time when a channel is established between the reader device and the CDN 100. Preloaded content may include, but is not limited to, advertising or database information such as telephone directory information or restaurant guide information.

The reader device 150a may utilize the preloaded content when the reader device 150a is not communicatively coupled to the channel. Accordingly, in some embodiments, the reader device may have the capability to display content for interactive applications in the absence of a channel connection. Preloading content may also reduce the occurrence of intermittent channel connectivity that may result from economic, environmental and/or transmission factors.

In some embodiments, the reader device 50a may be configured to receive a subscription to a digital edition, such as a digital newspaper; and/or emulate home delivery of paper newspapers and/or magazine through electronic delivery scheduled to be delivered at one or more selected times (e.g., every morning, 5 a.m., 7 p.m.). The timely delivery of a digital editions may be managed using a complex scheduling process between the reader device 150a and the distribution system 130 of the CDN 100, as described above.

A method for automatic creation of a digital edition may be as follows. Once the content is downloaded, processed and persisted in the data store, a publish task may be scheduled. The publish task may include one or more of the following processes: validation, release/aggregation, templating/packaging, building, and/or staging. One or more of these processes may be controlled by monolithic scheduler. The processes may be designed to provide robustness, scalability and/or maintainability.

The validation process may go through the downloaded/processed articles in the database and validate one or more articles at the time using build server components. It may build a miniature version of a digital edition of each article to ensure that the particular article does not break the build.

The release/aggregation process may select/mark the content (articles) to be included in the digital edition. Conditions for what should be included in the digital edition may be specified. By way of examples, but not limitations, the following conditions may be included in the digital edition: “all articles since 6 a.m.,” “articles published in the last 24 hours,” and “all articles since the last edition.” More targeted conditions may also be specified. By way of example, but not limitation, the following types of targeted conditions may be specified: “all articles about the Bailout in all newspapers published between 2 a.m. and 2 p.m.” The process may result in release identification information being associated with the selected (and validated) articles in the database.

The templating/packaging process may be performed at a logical level. [Please elaborate on the “differences between implementations” that you reference in your email noting that such differences can be discussed in another document.] The process may include one or more of the following steps: applying the publication's template to the articles flagged by the release process, which may result in an XHTML file, creating an ePub file which may package the XHTML file from the previous step, and downloading the images for articles included in the release, and/or logos and other images required by the template. This templating/packaging process may be an example of utiizing an active template, as discussed above. In various embodiments, the active template may be used for on-the-fly ad insertion, and/or personalized index pages.

The build process may include accepting the e-Pub file from the previous process and rendering a selected file format digital edition.

The staging process may include: providing an interface to allow a user to review a digital edition file generated by the previous process, and/or approving the digital edition file in the staging environment results in the file being transmitted to the one or more stores. The staging process may allow for configuration of a publication to be sent to multiple stores/servers upon approval.

The following assumptions for the creation of an electronic paper edition may be imposed: standard markup language, integration with tool chain and business logic, support from third-party design and authoring environments, support for adaptive, flexible design, abstraction and efficiency capability, and/or flexible publishing support to stores.

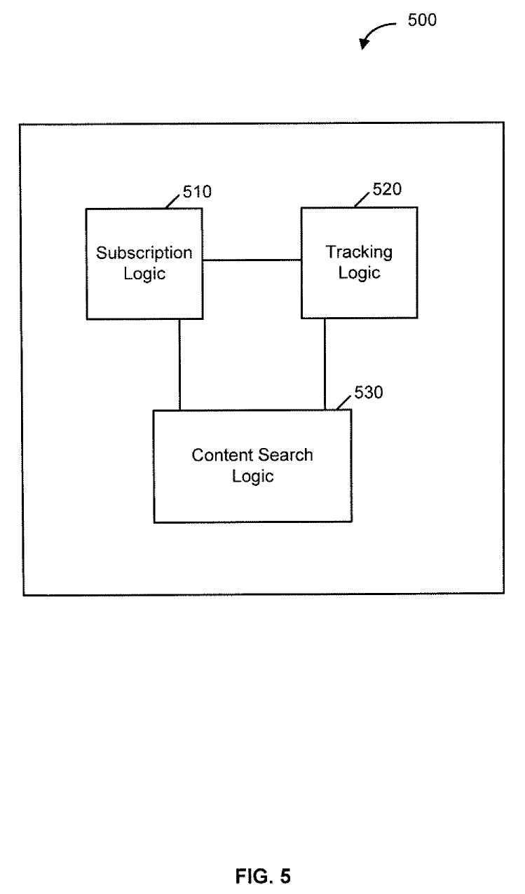

FIG. 5 is a block diagram of a subscription data processing system according to one embodiment of the invention. With reference to FIGS. 1 and 5, in some embodiments, the CDN 100 may include the subscription data processing system 500.

The subscription data processing system 500 may include subscription provisioning logic 510 communicatively coupled to tracking logic 520. The subscription provisioning logic 510 may be any logic configured to be capable of providing different types of subscriptions offered by publishers of content and/or users who view the content. The different types of subscriptions may include, but are not limited to, the following: generic, universal subscriptions to an entire newspaper, with updates, a personalized, universal subscription in which a user has access to the entire publication but tailors what the user receives by a criteria including, but not limited to, section, topic, keyword or author, a selective subscription in which a user receives only certain sections or coverage on an ongoing basis, and/or ad hoc subscriptions in which a user buys certain sections or articles individually.

The users may be able to subscribe to one or more publications in whole or in part. In one embodiment, a first newspaper may be a selling agent for a second newspaper if the first newspaper is already affiliated with the user at the point of user signup and customization with the second agent. Affiliation may refer to the ability of the CDN 100 to allow an end-user to create a personalized publication by selecting components of several publications, and combining them into a single digital edition. Affiliating may vary according to the ability or tendency of a publisher to provide atomicity at levels other than the full edition of the published content provided by the publisher. For example, if several different electronic newspapers are willing to release each section of their newspaper individually for this purpose, the individual section could be recombined by the end user to create a customized digital edition.

In some embodiments, the system 500 may provide system wide access that may be purchased for a certain time period (e.g., weekly, monthly, quarterly), or bulk access that may be valid across a range of content (e.g., news, sports).

The tracking logic 510 may be any logic configured to be capable of tracking the sale of newspaper content on an atomized basis and/or among and across publications. In various embodiments, the atomized basis may be an article-by-article basis and/or a section-by-section basis.

The content search logic 520 may be any logic configured to be capable of allowing search queries to be performed on the content database on a real-time or non-real-time basis. In various embodiments, the search may be performed directly on the website or on the reader device 150a only and the search results returned from the website to the reader device 150a when the reader device 150a next connects to the CDN 100. The website may be an online customer portal that may provide a search interface to the content database. The search interface may take any of a number of forms. The search interface may be accessed from a website or from the reader device 150a.

In the instant specification, various exemplary embodiments have been described with reference to the accompanying drawings. It will, however, be evident that various modifications and/or changes may be made thereto, and/or additional embodiments may be implemented, without departing from the broader scope of the invention as set forth in the claims that follow. The specification and/or drawings are accordingly to be regarded in an illustrative rather than a restrictive sense.

1. A system for electronic content distribution, the system comprising:
a processor having logic configured for:
filtering electronic content to remove incorrect information, the electronic content being automatically gathered from one or more content sources external to the system;
assembling, from the filtered electronic content, an electronic content indicative of a predetermined template; and
distributing the assembled electronic content for transmission at a scheduled time;
a communication network having one or more channels, at least one of the one or more of the channels being a first active channel configured to transmit the assembled electronic content; and
a media device communicatively coupleable to the first active channel and configured to receive the assembled electronic content from the first active channel when the media device is communicatively coupled to the first active channel, the media device also being configured to display the received assembled electronic content.

2. The system of claim 1, wherein the scheduled time is determined to optimize bandwidth usage in the communication network.

3. The system of claim 1, wherein the scheduled time is determined based on an estimated propagation time of the assembled electronic content.

4. The system of claim 3, wherein the estimated propagation time is determined based on a time zone in which the media device is located.

5. The system of claim 3, wherein the estimated propagation time is determined based on a number of media devices communicative coupled to the first active channel and a reliability of the first active channel.

6. The system of claim 1, wherein the media device is preloaded with data configured to be used for operating an interactive application on the media device when the media device is not communicatively coupled to the first active channel.

7. The system of claim 6, wherein the media device is preloaded with the data at a time of manufacture of the media device.

8. The system of claim 6, wherein the media device is preloaded with the data at a point of sale for the media device.

9. The system of claim 6, wherein the media device is preloaded with the data prior to the use of the data by the interactive application.

10. The system of claim 1, wherein the communication network includes a second active channel, the first active channel being configured for broadcast transmission to the media device, and the second active channel being configured for narrowcast transmission to the media device.

11. The system of claim 10, wherein the processor distributes the assembled electronic content for transmission over the first active channel or over the second active channel based on a type of the assembled electronic content.

12. The system of claim 11, wherein the type of the assembled electronic content is electronic newspaper content and the processor distributes the electronic newspaper content over the first active channel.

13. The system of claim 11, wherein the type of the assembled electronic content is electronic advertising and the processor distributes the electronic advertising over the second active channel.

14. The system of claim 1, the processor further comprising logic configured for analyzing feedback received from the media device.

15. The system of claim 14, wherein the feedback is indicative of a reliability of the communication network, a financial transaction performed with the media device, an advertisement transmitted along with the assembled electronic content or a quality of service of the transmission of the assembled electronic content.

16. The system of claim 1, the processor further comprising logic configured for providing multi-tiered support services to the media device.

17. The system of claim 1, the processor further comprising logic configured for performing a type of management associated with the media device, the type of management selected from a group consisting of: registration of the media device; updating software accessed by the media device; configuring the media device; and managing preferences of a subscriber associated with the media device.

18. The system of claim 1, the processor further comprising logic for providing an online store for purchase of a customized version of the assembled electronic content or for purchase of customized services configured to operate in association with the media device.

19. The system of claim 1, the processor further comprising logic configured for creating an online library including a portion of the assembled electronic content transmitted to the media device, the portion of the assembled electronic content being selected by a user of the media device.

20. A system for electronic content distribution to a media device, the system comprising:
a content management system configured to automatically gather the electronic content from one or more content sources external to and communicatively coupled to the system;
a pre-processing system configured to:
remove incorrect information from the gathered electronic content thereby generating an approved electronic content; and
store the approved electronic content in a canonical database;
a processing system configured to:
map the stored electronic content in a manner indicative of a predetermined template,
assemble the mapped electronic content into a plurality of articles;
perform quality control on the assembled electronic content; and
generate a final version of the assembled electronic content; and
a distribution system configured to:
map the final version of the assembled electronic content to a scheduler configured to schedule distribution of the final version of the assembled electronic content; and
distribute at a scheduled time over a communication network to the media device, the final version of the assembled electronic content and information for formatting a layout of the final version of the assembled electronic content on the media device.

21. The system of claim 20, wherein the electronic content is contained in a plurality of feeds and the content management system is further configured with strategy pattern software for parsing a selected one or more of the plurality of feeds.

22. The system of claim 20, wherein the content management system gathers the electronic content based on predetermined criteria indicative of the type of the electronic content.

23. The system of claim 22, wherein the type of the electronic content is selected from a group consisting of perishable, curated, on-line and personal electronic content.

24. The system of claim 20, wherein the electronic content is selected from the group consisting of: an electronic book content, an electronic newspaper content and an electronic magazine content.

25. The system of claim 20, wherein quality control is performed through one or more automated processes.

26. The system of claim 20, wherein performing quality control on the assembled electronic content includes operating a portal for allowing a publisher of the one or more content sources to approve the assembled electronic content, the portal being communicatively coupled to a website operated by the publisher.

27. The system of claim 20, wherein performing quality control on the assembled electronic content includes determining whether a number of the plurality of articles meets a selected threshold.

28. The system of claim 20, wherein performing quality control on the assembled electronic content includes determining whether a size of the plurality of articles meets a selected threshold.

29. The system of claim 20, further comprising the distribution system distributing at the scheduled time over the communication network to the media device, information for providing an enhanced service on the media device.

30. The system of claim 20, wherein the scheduled time optimizes bandwidth usage on the communication network.

31. The system of claim 20, wherein the scheduled time meets a required time of delivery of the final version of the assembled electronic content to the media device.

32. A computer-implemented method of managing a subscription data processing system, the method comprising:
providing information indicative of one or more types of subscriptions to electronic content offered for sale;
receiving information indicative of a request to search the types of the subscriptions;
searching a database according to the requested search, the database having information indicative of the electronic content;
providing information indicative of a result of searching the database;
receiving purchase information for purchasing at least one of the one or more types of subscriptions offered for sale; and
tracking sales of the one or more types of subscriptions.

33. The computer-implemented method of claim 32, wherein the type of subscription to the electronic content is selected from a group consisting of: a subscription to all of an electronic publication; a subscription to a selected topic within an electronic publication; and a subscription to a selected article within an electronic publication.

34. The computer-implemented method of claim 32, wherein the information indicative of the request to search is received from, and information indicative of the result of searching the database is provided to, a media device.

35. The computer-implemented method of claim 32, wherein searching the database is performed in real-time.
